(19) United States
(12) Patent Application Publication
(10) Pub. No.: US 2015/0376044 A1
(43) Pub. Date: Dec. 31, 2015

(54) Water purification process with water pretratment

(71) Applicant: Frederick J. Dart, Mississauga (CA)

(72) Inventors: Frederick J. Dart, Mississauga (CA); John O. Richmond, Toronto (CA)

(73) Assignee: Mary M.F. Richmond, Toronto (CA)

(21) Appl. No.: 14/756,339

(22) Filed: Aug. 31, 2015

Related U.S. Application Data
(63) Continuation-in-part of application No. 13/986,450, filed on May 6, 2013.

(51) Int. Cl. C02F 9/00; C02F 1/44; C02F 1/48; C02F 1/52

(52) U.S. Cl. CPC C02F 9/00; C02F 1/52; C02F 1/441; C02F 1/481; C02F 2103/08

(57) ABSTRACT

A water purification process for treating water containing at least some organic contaminants, and including the steps of pre-treating the water for capturing organic contaminants from solution in a water stream, by passing the water into a spin up bowl to speed up the water stream, forcing the high speed stream through an annular flow passage located centrally of the spin up bowl, passing the high velocity stream between a magnetic member and a magnetic ring, thereafter passing the water stream into an energy recovery bowl, directing the flow from the flow passage onto a zinc anode member; and thereafter passing the water stream along a grounded pipe, thereby causing the development if fine particles of calcium carbonates, and capturing the organic contaminants

This application is a Continuation in Part of U.S. application Ser. No. 13/986,450 filed; May 6, 2013 the priority of which is claimed

### FIELD OF THE INVENTION

The invention relates to a process for the purification of water, such as in reverse osmosis systems, and in particular to such a process incorporating the pretreatment of water prior to actual purification.

### BACKGROUND OF THE INVENTION

During processes for separating water from solute-filled sources, such as seawater, the removal of water molecules from the raw water supply, to produce purified water generates secondary waste streams. The waste streams have selective solute concentrations variously reaching saturation and even super saturation levels. Such solutes are of both mineral and organic composition. These may deposit as precipitation solids whenever and wherever the water makes its actual separation from the process stream, such as within the matrix of any reverse osmosis (RO) membranes being used. These deposits clog the membranes of RO systems. The periodic cleaning of membrane surfaces thus becomes standard practice to keep flows through the membranes at acceptable flux rates. Chemical cleaning does restore a considerable percentage of the original process rate. However it is inevitable that deteriorating recovery flux rates will result after each cleaning cycle. This will eventually require complete membrane replacement.

Cleaning cycle chemicals do essentially remove much of the inorganic scale accumulations. However many slower accumulations of organic contaminants within such membranes are not removed by cleaning. This is because any formulation strong enough to remove the organics would also be strong enough to attack the organic matrices of the membranes themselves.

It is therefore desirable to prevent organic contaminants from even entering operating membranes in the first place.

The type of organics that invade and plug up a membrane film might be characterized as similar to the slippery, gelatinous slimes that evolve naturally off of fish, seaweed, algae, bacteria, and the like. These have only slight hydrophilic solubilities and will form solidified gels once enough water has left them behind within the membrane. Once dehydrated, the jellied organics become insolubly locked in place with no suitable solubilizing reagents able to remove them.

The invention seeks to alleviate these problems by pretreating the water prior to contact with the membranes to cause much of these organics to settle out from the water stream. This is achieved by creating a growth of fine calcium carbonate [CaCO₃] particulates which are absorptive of up to 80% of any soluble natural organics (including brown tannins as exampled in brewed tea or natural brown waters).

The invention makes use of the calcium bicarbonates which are naturally found in the water stream and provides pre-conditioning steps which use turbulent motion within magnetic or electric fields to rip and separate the hydrogen ions [H⁺] away from the bicarbonate ions [HCO₃⁻] thus forming temporary increases in the formation of extra carbonate ions [CO₃⁼] in the water.

One form of such a conditioner is shown in an earlier magnetic device (U.S. Pat. No. 4,422,933).

The pre-conditioning process in accordance with the present invention is a major improvement on such earlier methods and devices. The present invention provides an adjustable-flow magnetic field device. The device further will allow major increases in flow volume capacity. Magnetic devices maintain an advantage with salt water where electrical fields of competing electrostatic units are strongly blocked by water conductivity as compared to magnetic field systems.

The large, though temporary, increases of the carbonate content in the water usually finds enough calcium ion [Ca²⁺] in most waters to supersaturate the water with respect to forming fine calcium carbonate [CaCO₃] scale precipitates. Simple chemical equations, such as below represent these conditioner reactions which may prevail for only about three seconds before the chemistry snaps back to normal pH-controlled ratios:

HCO₃⁻----->H⁺+CO₃⁼and CO₃⁺+Ca²⁺----->CaCO₃↓

Organic contaminants will be absorbed by the calcium carbonate, and largely formed into a buoyant suspension of fine particulates. The organic solutes most readily trapped within membranes generally are those most easily captured by the carbonate particulates.

While the absorption of organics on the precipitating calcium carbonate is a highly effective method of capturing a large proportion of such organic contaminants, it needs to be recognized that the growth of the carbonate crystals from the water is very much more effective than just contacting or dumping preformed calcium carbonate powder into the flow. The latter merely achieves a limited absorption of organics on the original preformed surfaces of the powder, whereas the active growing of the carbonate crystals from the soluble state absorbs organics at each layer of growing crystal formation as those crystals get assembled. Absorptions thus end up throughout the entire volume of the carbonate crystals, rather than just on the outside surface areas. The result is an increase in capture sites for organics by at least a 100-fold. Additionally, once the problem organics become incorporated within such scale particulates, they no longer have access to enter membrane pores to cause problems, and are further denatured by essential de-watering so that their original problematic qualities of being jelly-like or slimy can no longer be reestablished.

The invention, when treating larger seawater flows with enhanced effectiveness, represents more than just a minor improvement in water quality for subsequent reverse osmosis and other applications. Depending somewhat on local raw water contaminant levels and suitable installation and related flow adjustments, large cost efficiencies for desalination, for example, may be expected. Conservatively, sustained membrane flux rates between cleaning cycles could be expected to be at least double, and chemical and associated maintenance costs could be expected to be at least halved, and membrane replacements could be between 3 times to 10 times less frequent.

### BRIEF SUMMARY OF THE INVENTION

The invention seeks to provide a water purification process, providing the steps of introducing raw source water incorporating both inorganic and organic contaminants, settling out entrained material from the water, temporarily creating a calcium carbonate super saturation for depositing fragile crystalline carbonates for capturing organic contaminates, breaking off of said deposits into free particles, entraining them with the water stream, passing the water stream to a reverse osmosis filtration unit, continuously removing the inorganic contaminants and the calcium carbonate particles carrying the organic contaminants from the upstream side of the reverse osmosis system, while passing water molecules through the reverse osmosis membranes to produce desalted product water.

Preferably, the invention provides such a process in which a water purification pre-treatment process includes passing a water stream into an input spin-up chamber, passing the stream through a centrally located annular flow passageway and into an output chamber, while subjecting said stream to the action of a magnetic ring located around one side of the passageway, and of a magnetic member in said passageway, the magnetic ring and magnetic member defining a restricted annular flow path between them for flow of water from one chamber to the other, thereafter directing said stream onto a zinc anode body in said output chamber, and thereafter passing said stream through a downstream flow pipe connected to said outlet chamber for flow of treated water therefrom.

The input chamber is a circumferential flow bowl for receiving tangentially injected water from an outer rim and spinning the water around a spiral towards the central passageway, thus developing accelerated and angled velocities. This in turn results in both a longer passageway flow path and a consequential higher passage velocity through the passageway to enhance magnetic field action.

The outlet chamber is a circumferential kinetic energy recovery bowl receiving water after flowing through the central magnetic passageway thereby retrieving most of the flow pressure losses incurred in speeding up water flow against centrifugal forces in advance of the magnetic passageway. The input spin-up bowl traded flow pressure energy for increased water velocity for passage through the magnetic field [using the conservation of angular momentum, “L”=mv₁r₁=mv₂r₂, where “m” is water mass; “v₁” and “v₂” are the before and after velocities at corresponding circulating radii “r₁” and “r₂”], the receiving kinetic energy bowl hydraulically returns much of the velocity energy back into the original flow pressure. By channeling the flow in the direction of centrifugal forces this time in the manner of a water pump, flow pressure is much restored. In larger operations, having a relatively low pressure drop through the unit saves desirable energy.

The zinc anode within the kinetic energy bowl is sealed with O-ring seals to maintain corrosion-proof electrical contact. The zinc anode charges local metal components with an extra negative charge. In this way they will retain essential sites of nucleate carbonate scale adherent upon wetted surfaces for growing additional carbonate break-off particulates for capturing organic contaminants, and carrying their absorbed and denatured organics away from the RO membrane surfaces, to waste. Electrons supplied from the sacrificial anode assures that carbonate nucleating sites should develop and avoid becoming electrolytically cleaned off the exit plumbing by positive or stray alternating voltages.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a schematic block diagram illustrating the process of the invention;

FIG. 2 is a transverse section of the pretreatment apparatus; and,

FIG. 3 is a section along line 3-3 of FIG. 2;

### DESCRIPTION OF A SPECIFIC EMBODIMENT

As already outlined above, the invention relates to the a process for the modification of raw water which incorporates both inorganic contaminants and organic contaminants, in which the organic contaminants are of the type which can be sidelined by cloaking them within calcium carbonate particles. Such raw water typically is sea water, but is obviously not exclusive to sea water but is applicable to any raw waters which require purification for consumption, or improvement for use in any industrial process.

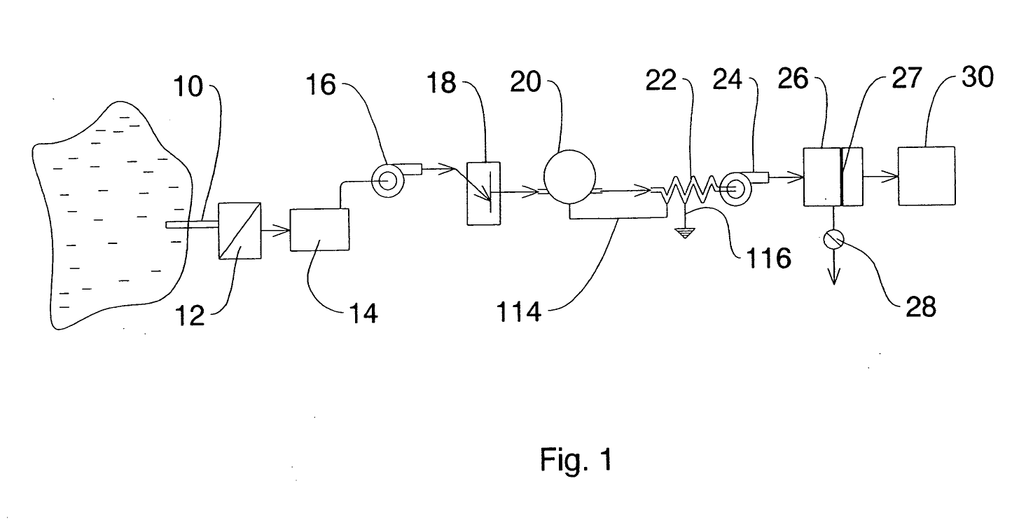

In general, a water purification process of this type takes place in a series of separate steps by means of a plurality of components, (FIG. 1) many of which are known and conventional. In particular typical components will comprise an intake (10) typically being a pipe immersed in a source of water. In many cases such a pipe will extend a considerable distance off shore, so as to be drawing in cleaner water, than is available along the shore. Water is than passed through a coarse screen (12) which is a barrier to remove components in the water or indeed live creatures namely fish, shells, and also seaweed and large pollutant material. The water is then passed to a sediment basin (14), settling out silt.

From the sediment basin, where the water is essentially still, for at least a certain period of time, a water pump (16) pumps the water to a fine screen (18). The fine screen typically removes any material which will not settle readily out from the water in the settlement basin. This may include for example, plankton. The water is then passed directly to a pre-conditioning unit (20), the details of which will be described below. The process of passing through the pre-conditioner (20) is to create a temporary production of calcium carbonate particles, by breaking up the bicarbonate ions present in the water, and then allowing the calcium carbonate particles to crystallize and absorb organic pollutants, in a manner described below.

From the pre-conditioner (20) water containing both inorganic components and also calcium carbonate particles with absorbed organic material, passes through an electrically grounded pipe (22). The effect of passing the water through the grounded pipe is to assist in a more complete creation of carbonate crystal scales. The water then passes to a high pressure pump (24) which creates a high pressure and forces the water into a reverse osmosis separator unit (26). Waste water containing the inorganic material and the calcium carbonate micro-particles is rejected by the reverse osmosis unit and is passed to waste (28). Water passing through the membrane, will be delivered to a storage tank (30). Water is then distributed as required.

This is a general description of the process of the invention. The rejection of the inorganic material and the created calcium carbonate particles with absorbed organic solutes takes place in the reverse osmosis unit itself. Such material is rejected continuously from the unit, along with surplus water which is a fraction of the water passed into the unit. Reverse osmosis systems avoid the inefficiencies of passing one hundred percent of the water itself through the purification membranes.

Therefore there is always a volume of waste water, in which the inorganic material and calcium carbonate particles are entrained and are rejected back to the raw water source.

It will be appreciated that this process does not increase the pollution of the raw water source, since the only material being returned to the raw water source is material which was extracted from it in the first place.

In accordance with the invention, the pre-treatment unit (20) and its operation are now described in more detail.

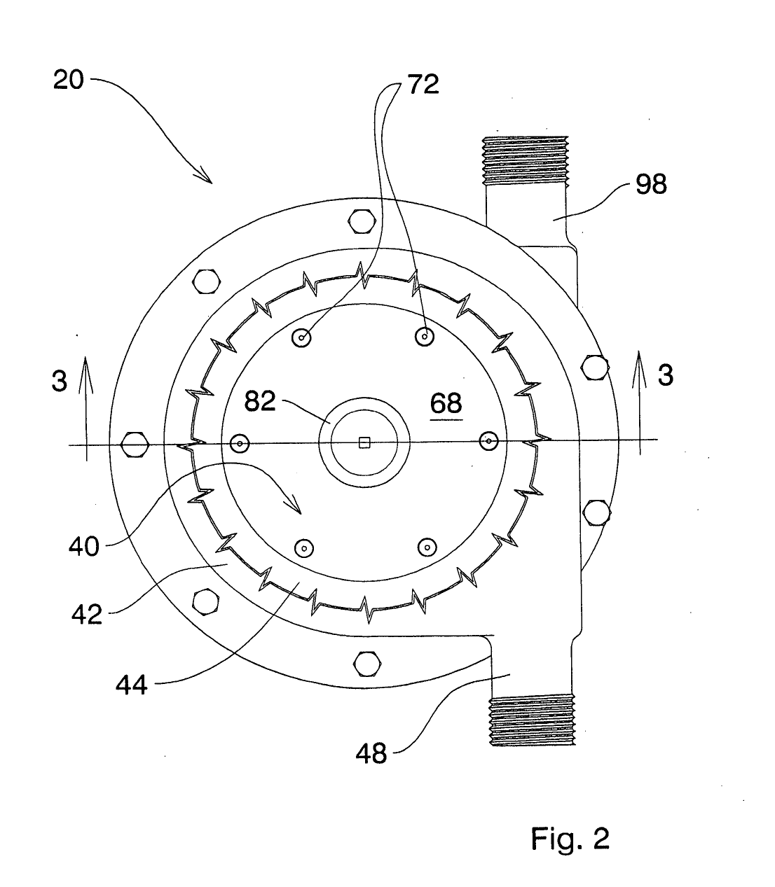

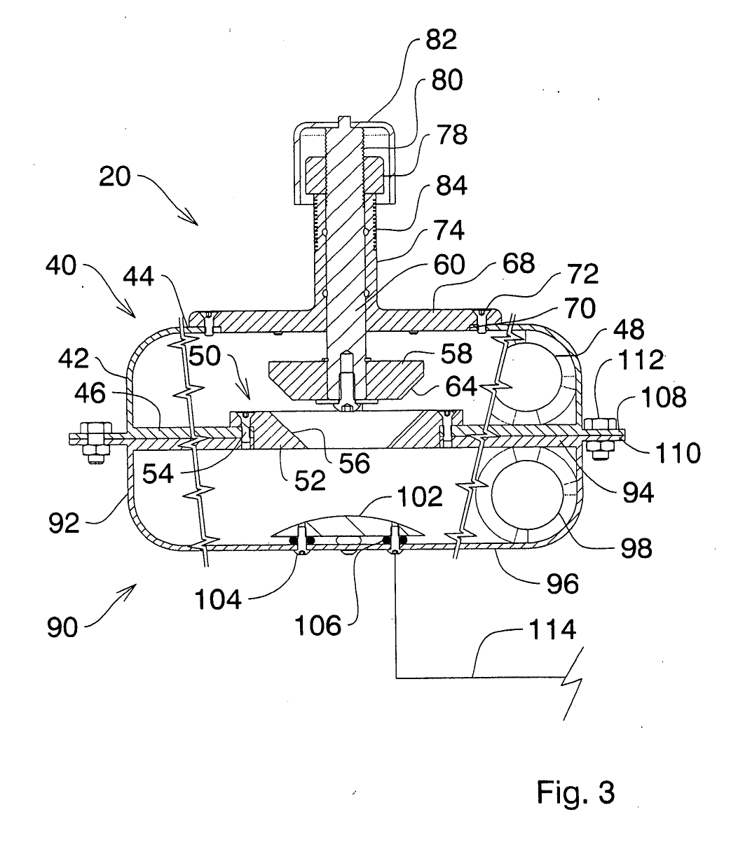

Referring now to FIGS. 2 and 3 it will be seen that the pre-treatment unit (20), comprises in this embodiment, an angular momentum spin-up input bowl (40), of circular shape and defining a generally arcuate outer perimeter wall (42), and an upper planar wall (44) and a lower wall (46). A water inlet (48) is positioned, more or less tangentially to the outer perimeter wall at its point of maximum circumference.

The inlet (48) delivers incoming water tangentially around the arcuate perimeter wall (42) of the spin up bowl. The lower wall (46) defines a central outlet opening (50). Around the central outlet opening (50) there is provided an annular magnetic ring (52) formed of ultra magnetic alloy. The annular ring (52) is secured in the opening by means such as screws (54). The annular ring (52) defines generally angled side walls (56), defining a circular opening, of progressively narrowing dimension, from top to bottom. A complimentary magnetic plug member (58) is formed of intense ultra magnetic alloy. The plug (58) is mounted on a movable spindle (60), which is adjustable vertically, thereby enabling the plug (58) to be moved towards or away from the ring (52). The plug (58) defines generally angular side walls (64), formed at angles complimentary to the angular side wall (56) of the ring (52). Ring (52) and member (58) can also be formed with protective corrosion resistant coatings containing magnetic minerals. Magnetite would be particularly suitable.

In this way, a central outlet passageway of annular shape is provided which narrows progressively from the top of ring (52) to the bottom of ring (52). The width of the annular opening may be adjusted by moving the spindle (60).

In order to support the spindle (60) there is provided an access plate (68), secured to an opening (70) in the upper wall (44) by screws (72). A vertical guide sleeve (74) extends from plate (68) and the spindle (60) is located in the sleeve (74), being sealed by O-ring seals (76).

At the upper end of sleeve (74), there is an internally threaded nut (78), secured to the top of the sleeve (74). The spindle (60) is threaded with complimentary male threads (80). A manually operated cap (82) which may or may not have an additional operating arm attached (not shown) is secured to the top end of spindle (60).

An adjustment scale (84) is formed on the exterior of sleeve (74).

By rotating the cap (82), the spindle (60) can be moved downwardly or upwardly as desired. In this way the dimensions of the gap between the ring (52) and the plug (58) can be adjusted along an externally calibrated scale.

The pre-treatment unit (20) further comprises a kinetic energy recovery bowl (90), located beneath the spin-up bowl (40). While the two bowls are respectively shown as upper and lower in the illustration, it will be appreciated that this is without limitation. The arrangement of the spin-up bowl and the recovery bowl may be varied depending on circumstances.

The recovery bowl (90) is seen to comprise a generally circular chamber defined by an arcuate side wall (92), and an upper planar wall (94) and a lower planar wall (96). An outlet opening (98) is provided, more or less tangential to the arcuate side wall and will be connected down stream to the next piece of equipment, namely the grounded pipe (22).

The kinetic energy recovery bowl (90) defines an inlet opening (100) in its upper wall (94). The annular ring (52) in the spin-up bowl is of sufficient thickness that it extends down through the opening (100) in the upper wall of the recovery bowl (90). Thus the lower end of the opening defined by the annular ring passes water directly to the recovery bowl (90). Directly opposite to such annular ring, an anode block (102) is secured to lower wall (96) of the recovery bowl (90). The anode block (102) is preferably formed of zinc or aluminum metal. It is secured in place by means of bolts (104) passing through lower wall (96) and the bolts (104) are provided with O-rings (106), so as to protect the connection between the anode block (102) and the lower wall (96). The function of the anode block is to receive the direct impact of water flowing through the annular ring (52) and to provide a source of electrons for protecting calcium carbonate nucleation sites generating particles off of local plumbing while temporary super-saturation of the treated water with said mineral still prevails.

Within the recovery bowl (90) the water will then spin in an outward spiral until it reaches the arcuate side wall (92), and will then exit through the outlet (98).

In order to provide a secure integral construction, external upper and under junction flanges (108) (110) are provided on the respective spin-up bowl and recovery bowl, and they are united together by fastening such as bolts (112).

The function of the pre-treatment unit (20) will thus become more readily understood. Water will enter the spin-up bowl (40) tangentially through the inlet (48), and will spin around in a spiral fashion, of ever decreasing diameter, until it exits through the central opening defined by the annular ring (52). Depending upon the adjustment position of the plug (58), the water will flow at a greater or lesser velocity, but will have accumulated considerable speed and energy during its rotation. Water flow rate is determined by the system pump, whereas the velocity through the magnetic gap for passing said flow is the factor set by the gap to interact with the magnetic field. As water passes through the magnetic gap between the ring (52) and the plug (58), the calcium bicarbonate molecules are temporarily broken apart so as to provide a source of temporary calcium carbonate molecules, and free hydrogen ions. As the water containing the temporary separated molecules impacts on the anode block (102), the calcium carbonate will be combining with the organic contaminants in the water and depositing out as crystals. The high velocity of the water flow will however break up the formation of fragile “frost-like” adhering crystals so that the water will acquire a suspension of crystalline fragments or particles.

The high velocity of the water exiting the ring (52) and impacting on the anode block (102) will be largely recovered as energy in the outwardly flowing water in the recovery bowl, which then exits through the outlet (98). Water exiting through the outlet (98) will contain a proportionate size of crystalline calcium carbonate particles, incorporating organic contaminants.

This water is then passed through the grounded pipe plumbing unit (22) which further assists in the formation of crystalline calcium carbonate combined with organic contaminants by providing additional nucleating surfaces while the exit water still retains some supersaturation—(typically up to about 3 seconds before return to a pH-controlled equilibrium). The maintaining of nucleating sites beyond the unit itself, thus, enhances the amount of scale particles that can be formed for absorbing troublesome organics. As treated water flows faster along the midline of the exit pipe, this zone identifies as the most freshly treated and hence the most supersaturated for growing crystal deposits. The result is that nucleating material grows fastest at the expanding tips of such deposits in fragile “hoarse frost-like” structures rather subject to breaking off by flow pressure to create said particles. Particles typically in the range of 70 to 150 microns have been observed by government laboratories.

The plumbing unit (22) generates additional crystalline calcium carbonate deposits while the “conditioned water” still retains much of its temporary calcium carbonate super saturation. Typically, some 10 to 15 feet long, plumbing unit (22) has pipe wall surfaces, which under appropriate conditions, acquire and retain calcium carbonate scale sites for sustaining the nucleation of further scale dendrites that break off as extra organic-scavenging particles.

To insure that such nucleating sites are retained against being redissolved by stray positive and AC voltages in the plumbing unit (22), particularly during non-flow periods, it is advantageous for the pipe to be of a single conductive metal, electrically connected as at (114) to the sacrificial zinc anode block (102), inside the bowl (90) itself.

The electrons available from the zinc's higher corrodability, protect carbonate deposit sites from the acid attack of ambient hydrogen ions (H*). The extra negatively-charged electrons (e−) from zinc block (102), aid in neutralizing such hydrogen ions into free hydrogen gas (H₂) before carbonates (CO₃⁼) can be converted back to soluble bicarbonates (HCO₃⁻).

Simple chemical equations such as:

2H⁺+2e⁻----->H₂ and CO₃⁼+H⁺----->HCO₃⁻(soluble)

may apply with the latter reaction being avoided by the electrons from the zinc block (102). Another problem arises from stray AC voltages from ubiquitous AC motors and related units which can cause electrolysis of sufficient potential across water-to-pipeline interfaces which “electro-clean” pipeline surfaces of their useful carbonate sites. For this reason, plumbing unit (22) is additionally grounded to earth, at (116), to short out such potential voltages.

These two features assist in maximizing the quantity of absorptive carbonate particles generated directly and thus minimizes the quantity of troublesome uncaptured organic material which would otherwise foul RO membranes.

Any remaining calcium carbonate, which has not attracted the organic material, ultimately recombines with the hydrogen ions to become re-solubilized as calcium bicarbonate.

This water is then passed via pump (24), to the reverse osmosis unit (26). In this unit, the fine calcium carbonate crystalline particles will remain on the upstream side of the reverse osmosis membrane (not shown). Water molecules will pass through the membrane and constitute the purified water outlet sent to tank (30). Water which does not pass through the membrane will flow continuously out to waste (28). This will entrain the majority of the calcium carbonate crystalline particles, thus maintaining the membrane as far as possible free of contaminants and membrane-blocking components. This will substantially increase regular product flow and the useful productive life of the membranes.

The waste water containing such crystalline calcium carbonate will then be returned to the original source.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A process of water purification, comprising the steps of:
creating a supply of raw source water incorporating both inorganic and organic contaminants;
settling out entrained material from the water;
treating the water magnetically to create a temporary over-saturation of paired calcium and carbonate ions; for contact with prior carbonate nucleate surfaces;
creating growth sites and growing thereon additional calcium carbonate crystal particles whose growth captures soluble organic contaminants;
breaking off said particles from their growth sites for entrainment in the water stream;
passing said water stream to a reverse osmosis filtration unit, having an upstream and a downstream side;
passing water molecules through the reverse osmosis system, to produce product water, while preventing passage of said particles and,
continuously removing the inorganic contaminants, and the calcium carbonate particles carrying the organic contaminants, from the upstream side of the reverse osmosis system.

2. The water purification process as claimed in claim 1 including the step of passing the water through a spin up bowl, a recovery bowl, and a restricted annular magnetic flow passage way between said bowls.

3. The water purification process as claimed in claim 2 including the step of varying the dimensions of said restricted annular magnetic flow passageway;

4. The water purification process as claimed in claim 2 including the step of flowing said water against a zinc anode body in said recovery bowl;

5. The water purification process as claimed in claim 4 including the step of passing the water stream containing calcium carbonate crystals from said recovery bowl through a conductive pipe, said pipe being connected both to said zinc body and to electrical ground.
